(19) United States
(12) Patent Application Publication
(10) Pub. No.: US 2026/0249634 A1
(43) Pub. Date: Aug. 27, 2026

(54) GLASS ARTICLE, METHOD FOR OBTAINING IT AND AUTOMOTIVE GLAZED UNIT COMPRISING SUCH A GLASS ARTICLE

(71) Applicant: SAINT-GOBAIN GLASS FRANCE, COURBEVOIE (FR)

(72) Inventors: Jalal BACHAROUCHE, COURBEVOIE (FR); Juliette JAMART, COURBEVOIE (FR); Kamel CHAHBOUNE, COURBEVOIE (FR); Sylvain LIGI, COURBEVOIE (FR)

(21) Appl. No.: 18/857,342

(22) PCT Filed: Apr. 25, 2023
(86) PCT No.: PCT/EP2023/060847

§ 371 Date: Oct. 16, 2024

(30) Foreign Application Priority Data
Apr. 28, 2022 (FR) FR2204030

(51) Int. Cl. B41M 1/34; C03C 3/087; C03C 17/00; C03C 17/04; C03C 17/34; C03C 17/36; C03C 19/00

(52) U.S. Cl. CPC B41M 1/34; C03C 3/087; C03C 17/002; C03C 17/008; C03C 17/04; C03C 17/3494; C03C 17/3605; C03C 17/3681; C03C 19/00; C03C 2217/485

(57) ABSTRACT

A glass article includes a glass substrate, a first layer at least partially covering the glass substrate and including at least one pigment chosen from dichroic pigments and metal pigments, and a second layer at least partially covering the glass substrate, substantially covering the entire surface of the first layer and including at least one black pigment.

### PRIOR ART

The invention relates to the field of glazed units, in particular automotive vehicle glazed units, for example windshields, rear, side, quarter windows, or even roofs.

Motor vehicle glazed units must meet a large number of requirements in terms of safety and comfort.

Such glazed units are often of unitary construction, comprising a single sheet of thermally tempered glass.

Alternatively, and to improve the safety as well as acoustic comfort, an increasing number of glazed units are laminated, that is, glazed units wherein two sheets of glass are adhesively bonded by means of a lamination interlayer. The latter may particularly retain glass splinters in the event of breakage, but also provides other functionalities, particularly in terms of resistance to breakage or improved acoustic properties.

Enamel layers, normally black and opaque, are often deposited on a portion of the glazed unit, generally in the form of a peripheral strip intended to hide, and protect from ultraviolet radiation, the polymer seals used to position and secure the glazed unit in the vehicle body window opening. They also make it possible to conceal said seals as well as other elements located on the glazed unit such as electrical connections or bus bars, intended to collect electricity.

An enamel is a mineral layer formed by firing an enamel composition comprising a glass frit, in particular bismuth borosilicate glass, and pigments.

In order to differentiate the vehicles by their design, automobile manufacturers are also looking for original decorations, in particular decorations visible outside of the vehicle, without however jeopardizing the safety as well as the light and thermal comfort of the occupants. Decorations making it possible to create a soft transition zone between the bodywork and the field of view are in particular sought.

Dichroic materials are known for their property of reflection of incident light radiation into reflected radiation of different wavelengths.

For example, in document US 2010/0330339 A1, decorative glasses are produced by the deposition of a dichroic film having an irregular surface. The film reflects or transmits light radiation of different colors according to patterns defined by the irregularity of the surface that it covers, its design and the angle of observation.

CN 102725663 B describes a dichroic coating that can be applied to a glass element of an electronic apparatus in order to improve the aesthetic appearance thereof. To these ends, several methods can be implemented, in particular the deposition of an ink layer on the glass in addition to a dichroic material.

Alternatively, document U.S. Pat. No. 6,531,230 B1 proposes a polymeric film comprising layers with different optical properties making it possible to obtain colored mirrors and polarizers. This film is characterized by a particularly uniform color variation as a function of the angle of observation.

### OVERVIEW OF THE INVENTION

The present invention therefore proposes, in order to obtain decorations making it possible to create a soft transition zone between the bodywork and the field of view in the field of automotive glazed unit, to implement such materials.

In order to describe such a transition, the term “seamless” is used.

To this end, and according to a first aspect, the invention relates to a glass article comprising:
a glass substrate,
a first layer at least partially covering the glass substrate and comprising at least one pigment selected from dichroic pigments and metal pigments, and
a second layer at least partially covering the glass substrate, substantially covering the entire surface of the first layer and comprising at least one black pigment.

In said glass article, various colorings are obtained as a function of the metallic and/or dichroic pigments used. The coloring, and therefore the pigments used, are chosen as a function of the color of the vehicle body with which the “seamless” effect is desired.

Such a glass article according to the invention is of interest, in particular, due to the fact that it also makes it possible to obtain different colorings as a function of the angle of observation of the glass article. This feature, linked to the first layer of a glass article according to the invention, makes it possible to better harmonize the glazed unit with a body. Indeed, the bodies in the automotive industry are also metallized, their coloring also depends on an angle of observation.

In addition, this first layer also makes it possible to give a metallized appearance to the glazed unit, which participates in the “seamless” effect obtained with the bodywork of a vehicle.

In one embodiment of the invention, it is sought to obtain this effect at a front windshield or a rear window of a vehicle, in contact with an vehicle body element, in order to attenuate the visual transition between these two elements of the vehicle.

In another embodiment, a glass article according to the invention is used as a replacement for metal parts usually used in vehicles at the interfaces between the glazed units and the body. In particular, such parts are found between the side windows and the doors or between the rear quarter windows and the quarter panels. A glass article according to the invention, used as side or quarter window, therefore makes it possible to dispense with said metal parts in a vehicle, occupying the space where the latter are usually located in order to obtain a “seamless” effect between the bodywork and the vehicle glazed unit.

The glass substrate suitable for a glass article according to the invention may be a sheet of mineral glass, optionally thermally tempered or chemically reinforced, in particular chosen from sheets of float glass, soda-lime glass, aluminosilicate and borosilicate glass.

Preferably, the glass substrate in a glass article according to the invention is a sheet of soda-lime-silica glass.

Pigments with a dichroic effect, called “dichroic pigments” are known to the person skilled in the art and described for example in patent EP 0 736 073 B1, referring to U.S. Pat. Nos. 4,434,010; 4,704,356; 4,779,898; 4,838,648; 4,930,866; 5,059,245; 5,135,812; 5,171,363 and 5,214,530.

These pigments generally have an interferential structure comprising at least one metallic reflective layer and at least one transparent dielectric layer. Said interferential structure produces the dichroic effect, typically via a dielectric stack of layers having different refractive indices or by the combination of transparent dielectric layer(s) and of semi-opaque metal layer(s).

The metallic reflective layer is generally made of aluminum, but may also be formed from gold, copper, or silver.

The semi-opaque metal layer may be formed from metals such as chromium, nickel or an alloy based on nickel, chromium, and iron.

The transparent dielectric layer may be formed from silica, magnesium fluoride or aluminum oxide.

The thickness of the layers varies as a function of the characteristics desired for the pigment.

Dichroic pigments which are suitable for the invention may be, for example, the pigments Ocean Blue Artikel 201003 and/or Magic Saphire Artikel 201006 sold by the company Ceramic Colors.

The second layer of a glass article according to the invention fulfills several roles. It allows mechanical protection, in particular scratch protection, as well as retention of the first layer. Furthermore, this second layer comprising a black pigment therefore causes an accentuation by contrast of the dichroic effect of the first layer.

In the present text, the term “covering” means a physical contact between the covered and covering layers. Thus, within the meaning of the invention, the first layer is in contact with the glass substrate and the second layer is in contact both with the glass substrate and the first layer.

Thus, in a preferred embodiment, the glass article according to the invention does not comprise any optically active layer between the glass substrate and the first layer, or when the second layer is in contact with the glass substrate, between the glass substrate and the second layer.

In a particular embodiment of the invention, the first layer comprises at least one pigment chosen from dichroic pigments.

In another embodiment of the invention, the first layer comprises at least one pigment chosen from metal pigments.

Such pigments are for example chosen from pigments based on mica and rutile titanium such as those sold under the references Iriodin and Xirallic by the company Merck.

A first layer suitable for the invention may for example be obtained by adding pigments suitable for the invention in a transparent enamel composition.

A first layer containing such pigments may also, for example, be obtained from the enamel compositions sold under the references 154030, 164030, 174030, 194030 and 134030 and preferably 194030 and 134030 by the company Vibrantz. These compositions correspond respectively to silver, copper, red, matte silver, and gold metal colorings.

The first layer of a glass article according to the invention may comprise a mixture of dichroic pigments and metal pigments.

A first layer suitable for the invention may contain from 5% to 15% by weight, in particular from 7% to 13% by weight; and preferably 10% by weight of pigment chosen from metallic and dichroic pigments, relative to the total weight of the first layer.

A first layer containing at least 5% by weight of pigment(s) suitable for the invention makes it possible to obtain a particularly satisfactory “seamless” effect.

A first layer containing at most 15% by weight of pigment(s) suitable for the invention has a viscosity that is particularly suitable for printing, in particular by screen printing, on a glass substrate.

The pigments included in the first layer of a glass article according to the invention generally have a size of from 5 to 40 μm. A particle size up to 120 μm may also be suitable for the invention, in particular so as to reinforce the visual effect produced by the pigment, but requires the use of suitable screens, with a high mesh opening, to implement a screen printing process as described below.

The first layer of a glazed unit according to the invention can be screened.

The screening of the first layer makes it possible, during the installation of the glazed unit on a vehicle, the observation of the second layer, black, through the openings formed in the first layer. The contrast between the two layers reinforces the aesthetic appearance of the glazed unit, in particular by accentuating the dichroic effect.

In a glass article according to the invention, the thickness of the first and second layer may be from 1 μm to 100 μm, in particular from 10 μm to 80 μm and preferably from 15 μm to 50 μm.

The first and second layer may further comprise a glass frit.

In a particular embodiment, these layers correspond to enamels, comprising a glass frit, pigments, and an organic medium before firing and then pigments and a glassy matrix obtained by melting the glass frit after firing. The term “enamel” is intended to denote the layer both before and after firing. These enamels are typically obtained by firing above 500° C.

The glass frit and/or the vitreous matrix preferably consists of a bismuth and/or zinc borosilicate. Preferably, the glass frit and/or the vitreous matrix is bismuth silicate.

In the second layer, the at least one, in particular each, pigment is preferably based on an oxide or a sulfide of iron, chromium, copper, cobalt, and/or manganese. Preferably, the black pigment is copper chromate.

According to another of its aspects, the present invention relates to a method for obtaining a glass article as defined above, comprising:
a step of printing the first layer on the glass substrate; and
a step of printing the second layer on the first layer and the glass substrate.

In one embodiment of the invention, the printing steps are carried out by screen printing and/or by digital printing.

Screen printing method comprises the deposition, in particular using a squeegee, of a pasty liquid onto the glass sheet through meshes of a screen-printing screen. The apertures of the screen are blocked off in the portion corresponding to the zones of the glass sheet which are not to be coated, such that the paste can only pass through the screen in the zones to be printed, according to a predefined design. Selective blocking of the apertures is therefore done according to the negative of the design to be printed.

This selective blocking is generally carried out by application on the screen of a photo-crosslinkable resin and then by irradiating, by ultraviolet radiation, the parts of the screen to be blocked.

Selective irradiation is for example carried out using a slide comprising a transparent holder, typically made of polyester, coated with an ink opaque to ultraviolet deposited according to the pattern to be printed.

The mesh of the screen is chosen according to the viscosity and the surface tension of the paste as well as according to the desired thickness for the resulting layer of the deposition by screen printing.

The screens used for the screen printing of the first and second layers may comprise from 30 to 100 wires per centimeter, for a wire diameter of from 30 to 60 μm.

The screens used for screen printing the first layer must have a relatively large mesh opening, which results in a maximum number of wires.

The screens used for the screen printing of the first layer can therefore comprise up to 75, in particular up to 70 and preferably 68 wires per centimeter.

In particular, the screens used for the first layer comprise from 40 to 70 wires per centimeter, for a wire diameter of from 40 to 60 μm.

Preferably, the screens used for the first layer comprise 68 wires per centimeter, for a wire diameter of 55 μm.

To obtain an even higher mesh opening and prevent any blockage of the fabric, even more preferably, the screens used for the first layer comprise up to 49 wires per centimeter.

The screens used for the screen printing of the second layer must allow a sufficiently thick deposition to cover the first layer and completely encapsulate the pigments contained in this first layer.

In particular, the screens used for the second layer comprise from 80 to 100 wires per centimeter, for a wire diameter of from 30 to 50 μm.

Preferably, the screens used for the second layer comprise 90 wires per centimeter, for a wire diameter of 40 μm.

In another embodiment of the invention, the screens used for the second layer comprise from 45 to 65 wires per centimeter, for a wire diameter of from 55 to 75 μm. Preferably, in this other embodiment, the screens used for the second layer comprise 55 wires per centimeter, for a wire diameter of 64 μm.

According to yet another one of its aspects, the present invention relates to a motor vehicle glazed unit comprising a glass article according to the invention.

In a glazed unit according to the invention, the surface on which the first and second layers extend is called “enameled zone”.

The enameled zone is in particular in the form of a peripheral strip. That is, a strip that is enclosed on itself which, of each point of the glass article according to the invention, extends toward the interior of the glass article over a certain width, typically between 1 and 20 cm.

The remaining portion of the automotive glazed unit according to the invention, called “non-enameled zone” is generally uncoated.

Alternatively, it may be coated with a stack of thin layers, for example comprising a low-emissivity layer, in particular based on silver or based on a transparent electroconductive oxide such as indium and tin oxides or doped tin or zinc oxides.

In a particular embodiment, the automotive glazed unit according to the invention is a laminated or tempered glazed unit.

When the glazed unit according to the invention is laminated or tempered, the first and second layers can advantageously be deposited on the inner face of this glazed unit.

“Inner face” refers to any face of a glass sheet of the glazed unit, arranged facing the passenger compartment of a vehicle. For example, for a tempered glazed unit, it may be the face in contact with the interior of the passenger compartment of the vehicle, or, in the case of a laminated glazed unit, the inner face of the exterior glass, that is to say, the one located on the side of the lamination interlayer.

When the automotive glazed unit according to the invention is tempered, the tempering thereof is advantageously carried out simultaneously with the firing of the first and second layers.

The automobile glazed unit according to the invention may be curved.

The glass substrate on which the first and second layers are deposited is generally flat. Said substrate is then preferably bent and therefore has a curved shape in the automotive glazed unit according to the invention.

The bending of the glazed unit has the effect of increasing the “seamless” printing for an observer. Indeed, relative to a flat glass or with a less pronounced rounding, the observation from the same point results in a greater range of observation angles and thus a greater color range of the glazed unit, since, as shown in the examples below, it varies according to the angle of observation of the glazed unit.

When the automotive glazed unit according to the invention is curved, the bending thereof is advantageously carried out simultaneously with the firing of the first and second layers.

The glazed unit according to the invention may comprise an enameled zone of from 2 to 25%, in particular from 3 to 20% and preferably from 5 to 15% of the surface area of its face coated with the first and second layers.

### EXAMPLES

The table below shows the configurations that were produced and in particular indicates the mass percentage of pigments in a layer relative to the total mass of pigments in this layer.

TABLE 1

| | | Ex. 1 | Ex. 2 | Ex. 3 | Ex. 4 | Ex. 5 | Ex. 6 |
|---|---|---|---|---|---|---|---|
| First | Ocean Blue | 100 | — | 50 | — | — | — |
| layer | Artikel 201003 | | | | | | |
| Mesh | from Ceramic | | | | | | |
| 68.55 | Colors (%) | | | | | | |
| | Magic Saphire | — | 100 | 50 | — | — | — |
| | Artikel 201006 | | | | | | |
| | from Ceramic | | | | | | |
| | Colors (%) | | | | | | |
| | 194030 from | — | — | — | 100 | — | 50 |
| | Vibrantz (%) | | | | | | |
| | 134030 from | — | — | — | — | 100 | 50 |
| | Vibrantz (%) | | | | | | |

| | Viscosity (Pa · s) | 8 ± 2 | 14 ± 2 |
|---|---|---|---|
| | Thickness (μm) | 33 ± 2 | 24 ± 2 |
| Second | Ferro 14501 (%) | 100 | |
| layer | Viscosity (Pa · s) | 13 ± 2 | |
| | Thickness (μm) | 35 ± 2 | 42 ± 2 |
| | Mesh | 90.40 | 55.64 |

For each of the examples, a sheet of glass was enameled by deposition via screen-printing of the first and second layers described in Table 1 above. In the case of examples 3 and 6, a homogeneous mixture of the pigments was carried out before the deposition.

A screen comprising 68 wires per centimeter and whose wire diameter is 55 μm was used for the deposition of the first layer.

A screen comprising 90 wires per centimeter and whose wire diameter is 40 μm was used for the deposition of the second layer for examples 1 to 3.

A screen comprising 55 wires per centimeter and whose wire diameter is 64 μm was used for the deposition of the second layer for examples 4 to 6.

It should be noted that the thicknesses and viscosity measurements indicated in Table 1 above were carried out before the firing step.

After the depositions, a drying time of 2 minutes at 150° C. was respected. Then, the glass sheets bearing the two layers were subjected to a firing step at 650° C. for 180 seconds.

The firing step is carried out in a convection oven reproducing the conditions of an industrial process for the production of glass intended for the automotive industry. It was observed that these conditions always make it possible to obtain the desired “seamless” effect.

The samples obtained were also curved. It was observed that the bending has no influence on the materials allowing a dichroic effect to be obtained. Said effect is therefore always achieved.

The reflection spectrum of example 1 as well as its luminosity (L*) were measured for different angles using a spectrophotometer (Lambda 1050) using the “Total Absolute Measurement System” (TAMS) module allowing simultaneous rotation and acquisition of data. These measurements are presented in Table 2 below.

TABLE 2

| | −75° | −60° | −45° | −30° | −15° | 15° | 30° | 45° | 60° | 75° |
|---|---|---|---|---|---|---|---|---|---|---|
| RL (%) | 27.62 | 10.25 | 6.01 | 5.08 | 4.97 | 4.98 | 5.06 | 5.89 | 9.75 | 25.61 |
| L* | 59.54 | 38.28 | 29.43 | 26.96 | 26.65 | 26.66 | 26.91 | 19.14 | 37.39 | 57.67 |
| a* | 0.09 | 0.35 | 0.07 | −0.84 | −1.44 | −1.52 | −0.9 | 0.05 | 0.33 | 0.06 |
| b* | 0.2 | −0.4 | −1.29 | −1.6 | −1.35 | −1.52 | −1.61 | −1.36 | −0.57 | −0.08 |

The luminosity (L*) varies from black (0) to white (100) while a* represents a coloration ranging from green (negative) to red (positive) and that b* represents a coloration ranging from blue (negative) to yellow (positive).

Table 2 shows the clear variation in color and luminosity of the sample as a function of the angle of observation thereof. It is also important to recall that under actual conditions of use, this variation would even be greater because the angle of observation could then vary according to more than one direction.

It therefore appears that a glass article according to the invention makes it possible to cover a wide range of colorations and thus can be harmonized with a body element of a vehicle.

The inventors also noted that the mixture of two dichroic pigments, such as in examples 3 and 6 below, makes it possible to obtain an even higher number of colorings on the same glass substrate, relative to, respectively, examples 1-2 and 3-4.

1. A glass article comprising:
a glass substrate,
a first layer at least partially covering the glass substrate and comprising at least one pigment selected from dichroic pigments and metal pigments, and
a second layer at least partially covering the glass substrate, substantially covering the entire surface of the first layer and comprising at least one black pigment.

2. The glass article according to claim 1, wherein the at least one pigment comprised in the first layer is chosen from dichroic pigments.

3. The glass article according to claim 1, wherein the first layer comprises a mixture of dichroic pigments and metal pigments.

4. The glass article according to claim 1, wherein the first layer is screened.

5. The glass article according to claim 1, wherein the first and second layers have a thickness of from 1 μm to 100 μm.

6. The glass article according to claim 1, wherein the first and second layers further comprise a glass frit.

7. The glass article according to claim 1, wherein the first layer comprises from 5% to 15% by weight of pigment chosen from metallic and dichroic pigments, relative to the total weight of the first layer.

8. The glass article according to claim 1, wherein the glass substrate is a sheet of mineral glass, optionally thermally tempered or chemically reinforced.

9. The glass article according to claim 1, wherein no optically active layer is included between the glass substrate and the first layer, or when the second layer is in contact with the glass substrate, between the glass substrate and the second layer.

10. A method for obtaining a glass article according to claim 1, comprising:
a step of printing the first layer on the glass substrate, and
a step of printing the second layer on the first layer and the glass substrate.

11. The method according to claim 10, wherein the printing steps are carried out by screen printing and/or by digital printing.

12. A motor vehicle glazed unit, comprising a glass article according to claim 1.

13. The automotive glazed unit according to claim 12, said glazed unit being laminated or tempered.

14. The automotive glazed unit according to claim 13, wherein the first and second layers are arranged on the interior face.

15. The automotive glazed unit according to claim 12, said glazed unit being curved.

16. The glass article according to claim 5, wherein the first and second layers have a thickness of from 10 μm to 80 μm.

17. The glass article according to claim 16, wherein the first and second layers have a thickness of from 15 μm to 50 μm.

18. The glass article according to claim 7, wherein the first layer comprises from 7% to 13% by weight of pigment chosen from metallic and dichroic pigments, relative to the total weight of the first layer.

19. The glass article according to claim 8, wherein the glass substrate is a sheet of float glass, soda-lime-silica glass, aluminosilicate or borosilicate glass.

20. The glass article according to claim 19, wherein the glass substrate is a sheet of soda-lime-silica glass.
